(19) United States
(12) Patent Application Publication
(10) Pub. No.: US 2010/0131548 A1
(43) Pub. Date: May 27, 2010

(54) METHOD AND APPARATUS FOR GENERATING CONTENT PLAYLIST USING METADATA

(75) Inventors: Ji-bum MOON, Seoul (KR); Yoo-jin CHOI, Seoul (KR); Se-jun PARK, Suwon-si (KR); Min-jung PARK, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/492,179

(22) Filed: Jun. 26, 2009

(30) Foreign Application Priority Data
Nov. 24, 2008 (KR) 10-2008-0117057

(51) Int. Cl. G06F 17/30; G06F 3/01

(52) U.S. Cl. 707/769; 715/702; 707/E17.014; 707/E17.009

(57) ABSTRACT

Provided is a method of generating a content playlist. The method includes: selecting an item of content included in a first content playlist, selecting a metadata item, which is a search base, from one or more items of metadata associated with the selected item of content, searching for one or more contents having a metadata item value equal to or similar to a metadata item value of the selected metadata item, and generating a second content playlist using the searched for one or more contents.

### CROSS-REFERENCE TO RELATED PATENT APPLICATION

This application claims priority from Korean Patent Application No. 10-2008-0117057, filed on Nov. 24, 2008, in the Korean Intellectual Property Office, the disclosure of which is incorporated herein in its entirety by reference.

### BACKGROUND OF THE INVENTION

1. Field of the Invention

Methods and apparatuses consistent with the present invention relate to generating a content playlist using metadata and a computer-readable recording medium storing a program for executing the method.

2. Description of the Related Art

As digital storage devices have recently shown remarkable progress in terms of capacity and compression technology has been improving, the amount of content that can be stored in a digital storage device has increased dramatically. This consequently makes it difficult for a user to search for and reproduce desired content. This problem is made worse if the digital storage device has a small display area, such as a portable MPEG layer-3 (MP3) player or a portable multimedia player (PMP).

In order to efficiently reproduce content, a method exists where metadata is used to search for content and then the content is sequentially or randomly reproduced. However, the method is basically about searching for one item of content. In order to manage a plurality of contents, there is a demand for a method of generating a new content playlist using metadata and switching an existing content playlist to the new content playlist.

### SUMMARY OF THE INVENTION

The present invention provides a method and apparatus for generating a new content playlist by using metadata and switching an existing content playlist to the new content playlist.

According to an aspect of the present invention, there is provided a method of generating a content playlist based on metadata including one or more metadata items, the method comprising: selecting an item of content from contents included in a first content playlist; selecting a metadata item, which is a search base, from one or more metadata items of metadata associated with the selected item of content; searching for one or more contents each having a metadata item value equal to or similar to a metadata item value of the selected metadata item; and generating a second content playlist using the searched for one or more contents.

The selecting the item of content from the contents included in the first content playlist may comprise allowing the one item of content to be selected by a user or a control unit.

The selecting the metadata item, which is the search base, may comprise selecting the metadata item while the selected item of content is being reproduced.

The metadata may comprise at least one metadata item selected from a group consisting of an artist, an album, a genre, a title, a size, a date, and a content format.

The selecting of the metadata item, which is the search base, may comprise: displaying the one or more metadata items of the metadata associated with the selected item of content; and selecting the metadata item, which is the search base, from the displayed one or more metadata items.

The selecting the metadata item, which is the search base, may comprise: receiving an input signal which changes the metadata item that is the search base; and selecting a new metadata item, which is a second search base, in a preset metadata item change order when the input signal is received.

According to another aspect of the present invention, there is provided an apparatus for generating a content playlist, the apparatus comprising: an information input unit which inputs information; a storage unit which stores a first content playlist including one or more contents; a search unit which selects an item of content from the one or more contents included in the first content playlist, and which searches for one or more contents each having a metadata item value equal to or similar to a metadata item value of a metadata item of metadata associated with the selected item of content; and a control unit which generates a second content playlist using the searched for one or more contents.

According to another aspect of the present invention, there is provided a computer-readable recording medium having embodied thereon a program for executing the method.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for generating a content playlist, according to an exemplary embodiment of the present invention;

FIG. 2 is a view for explaining a method of driving the apparatus of FIG. 1 when a content type is a song, according to an exemplary embodiment of the present invention;

FIG. 3 is a view for explaining a method of driving the apparatus of FIG. 1 when a content type is a song, according to another exemplary embodiment of the present invention;

FIG. 4 is a view for explaining a method of driving the apparatus of FIG. 1 when a content type is a song, according to another exemplary embodiment of the present invention;

FIG. 5 is a view for explaining a method of driving the apparatus of FIG. 1 when a content type is an image, according to an exemplary embodiment of the present invention;

FIG. 6 is a view for explaining a method of driving the apparatus of FIG. 1 when a content type is an image, according to another exemplary embodiment of the present invention; and

FIG. 7 is a flowchart illustrating a method of controlling a digital storage device using an apparatus for generating a content playlist, according to an exemplary embodiment of the present invention.

### DETAILED DESCRIPTION OF THE INVENTION

The present invention will now be described more fully with reference to the accompanying drawings, in which exemplary embodiments of the invention are shown.

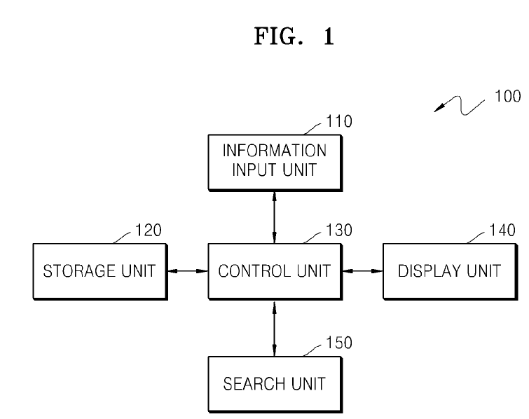

FIG. 1 is a block diagram of an apparatus 100 for generating a content playlist, according to an exemplary embodiment of the present invention. Referring to FIG. 1, the apparatus 100 includes an information input unit 110, a storage unit 120, a control unit 130, a display unit 140, and a search unit 150.

The storage unit 120 stores one or more contents, metadata about the one or more contents, and metadata item values of metadata items of the metadata. If a content type is a song, the metadata items, which are categories, may be an album, an artist, and a genre, and the metadata item values may be an album name, an artist name, and a genre name. If a content type is an image, the metadata items may be a date, a size, and a folder, and the metadata item values may be a date photographed, an image size (horizontal/vertical), and a folder name.

The storage unit 120 may temporarily store a metadata item that is selected as a search base by a user. The information input unit 110 is used to input the metadata item that is the search base for the purpose of switching a content playlist.

The storage unit 120, which electromagnetically stores data, may be, for example, a random access memory (RAM), a hard disk, and a tape.

The information input unit 110 allows the user to select desired information and enter the desired information. In detail, the information input unit 110 allows the user to select desired information based on information displayed on the display unit 140. If the user wants to select the metadata item that is the search base, the user may select the metadata item that is the search base by searching through menus or directly inputting the metadata item on a screen. A detailed explanation of a method of inputting a metadata item will be explained later.

If a digital storage device is an MPEG layer-3 (MP3) player or a portable multimedia player (PMP), the information input unit 110 may be a selection key, a direction key, or a touchpad. If the digital storage device is a personal digital assistant (PDA), the information input unit 110 may be a touchpad, a numeric keypad, or an alphabetic keypad. If the digital storage device is a computer, the information input unit 110 may be a keyboard, a mouse, or a touchpad. The information input unit 110 may be configured to receive the user's voice by using speech recognition or receive the user's motion by using motion recognition to allow the user to select desired information.

The control unit 130 confirms a metadata item value of current content, which is currently being reproduced, based on the metadata item that is selected by the user using the information input unit 110. Next, the control unit 130 requests the search unit 150 to search for contents each having a metadata item value associated with the confirmed metadata item value. That is, the control unit 130 requests the search unit 150 to search for contents each having a metadata item value that is equal or similar to the metadata item value of the metadata item that is selected as the search base by the user.

For example, if the user selects a metadata item ‘artist’, among metadata items, using the information input unit 110 while music files of an artist name ‘MIKA’ which is a metadata item value are being reproduced, the control unit 130 requests the search unit 150 to search for music files each having a metadata item value that is equal or similar to the metadata item value “MIKA” of the metadata item ‘artist’.

Next, the control unit 130 generates a new content playlist by using the contents which have been searched, and stores the generated new content playlist in the storage unit 120.

If the control unit 130 requests music files each having a metadata item value that is equal or similar to the metadata item value “MIKA”, the search unit 150 searches for one or more contents each having a metadata item value that is the metadata item value “MIKA” of the metadata item ‘artist’ or “MIKE” similar to the metadata item value “MIKA”.

The generated new content playlist may be transmitted to the display unit 140. If the new content playlist is displayed on the display unit 140, some of contents of the new content playlist may be selected by the user, and may be reproduced by the control unit 130, reserved to be reproduced after a predetermined period of time, or registered in another content playlist.

The search unit 150 extracts contents each having a metadata item value associated with the metadata item value of the metadata item, that is the search base among contents stored in the storage unit 120, by using the metadata item that is the search base, and is received from the control unit 130. The metadata item value of each of the extracted contents may be equal or similar to the metadata item value of the current content that is currently being reproduced, or equal or similar to a metadata item value that is newly searched using the metadata item value of the current content as a keyword.

In order to register the contents which have been searched in the new content playlist, the search unit 150 transmits identification information for identifying the searched contents to the control unit 130. Although information on titles of the contents which have been searched is usually used as the identification information for identifying the contents, information on one of metadata item values associated with the contents, such as a folder name, a time stored, and a genre name, may be used as the identification information for identifying the contents.

The display unit 140 may display the contents, the new content playlist of the contents, and the metadata item that is selected as the search base by the user.

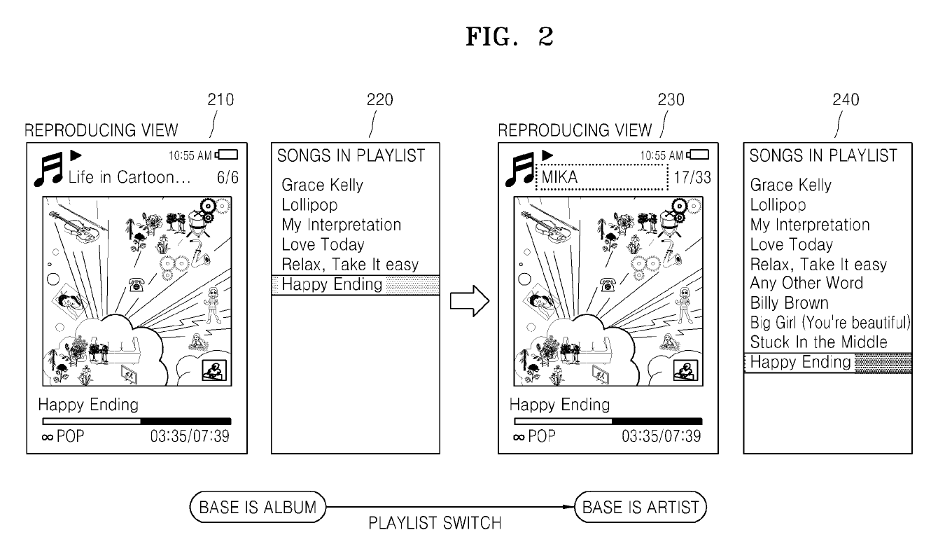

FIG. 2 is a view for explaining a method of driving the apparatus 100 of FIG. 1, according to an exemplary embodiment of the present invention. In FIG. 2, the method switches an existing content playlist 220 to a new content playlist 240 by changing a metadata item that is a search base which is used to generate the new content playlist, to any metadata item associated with current content that is currently being reproduced.

Referring to FIG. 2, if the user selects one item of content from contents included in the existing content playlist 220, which is displayed on the display unit 140, using the information input unit 110, a first view 210 of the selected content is displayed. If a content type of the selected item of content is a song, an image, an album, a thumbnail, lyrics, and a moving picture associated with the song may be displayed while the song is playing. The existing content playlist 220 may be displayed so that the user can select the item of content, or the existing content playlist 220 may only be stored in the storage unit 120 without being displayed. The contents included in the existing content playlist 220 may be reproduced in a predetermined order or in a random order.

If the user selects a metadata item, which is a search base for switching the existing content playlist 220 to the new content playlist 240, using the information input unit 110 while the selected content is currently being reproduced, the control unit 130 searches for contents each having a metadata item value associated with a metadata item value of the selected metadata item.

Although the user usually selects the metadata item that is the search base while the selected content in the existing content playlist 220 is currently being reproduced, the user may select an item of content from the contents included in the existing content playlist 220 without any reproduction. The contents which have been searched are included in the new content playlist 240 that is generated by the control unit 130, and one of the contents of the new content playlist 240 may be displayed in a second view 230 and may be reproduced according to the user's command or may be reproduced automatically. The new content playlist 240 may be displayed along with current content that is currently being reproduced, or may only be stored in the storage unit 120 without being displayed.

Examples of the display unit 140 may include not only a display device, such as a cathode ray tube (CRT), a liquid crystal display (LCD), an organic light emitting diode (OLED), or an electrochromic display (ECD), but also any type of display that can visually output data to the user. The data displayed on the display unit 140 may consist of text, a graphical user interface (GUI), images, audio, or motion.

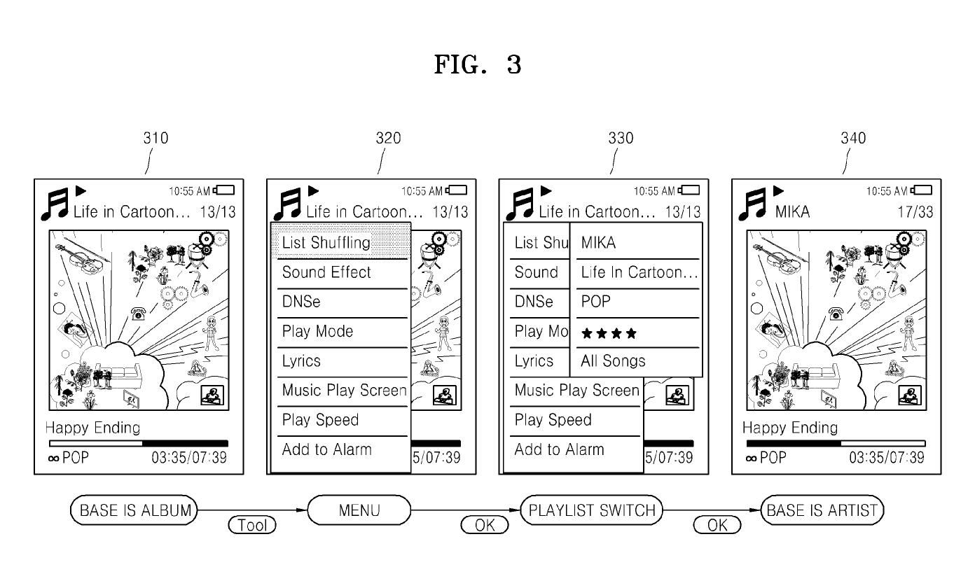

FIG. 3 is a view for explaining a method of driving the apparatus 100 of FIG. 1, according to another exemplary embodiment of the present invention. In FIG. 3, the user switches an existing content playlist to a new content playlist, based on a metadata item of content that is currently being reproduced, by using a menu.

Referring to FIG. 3, a menu “List Shuffling” is displayed in a second view 320 according to the user input in a first view 310. The menu “List Shuffling” for switching the existing content playlist may be displayed by pressing a menu button (not shown) provided on the display unit 140 or pressing a button (not shown) attached to an outer surface of the apparatus 100.

Once the menu “List Shuffling” for switching the existing content playlist is selected, a sub menu for selecting a metadata item that is a base for generating the new content playlist is displayed in a third view 330. The third view 330 displays one or more metadata item values or one or more metadata items associated with the content that is currently being reproduced.

The third view 330 of FIG. 3 displays metadata item values of the current content. The user may select a metadata item value that is a base for generating the new content playlist from the displayed metadata item values. For example, in the third view 330, the user selects an artist name “MIKA” as the metadata item value that is the base. Next, contents each having a metadata item value that is equal or similar to the metadata item value “MIKA” are searched for by the search unit 150. The searched for contents are registered in the new content playlist by using identification values, and the contents included in the new content playlist may be reproduced according to the user's command or may be reproduced automatically.

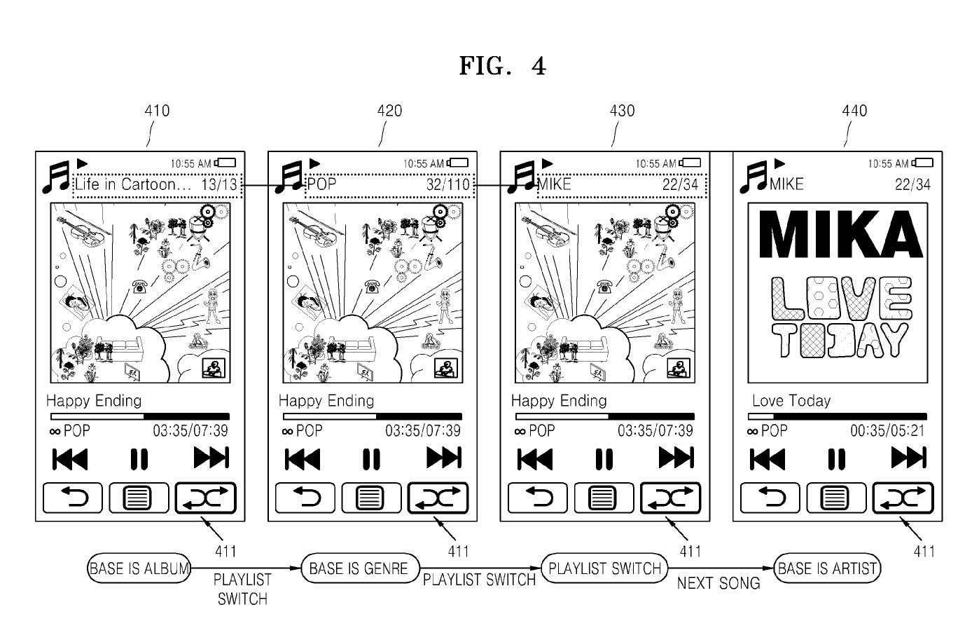

FIG. 4 is a view for explaining a method of driving the apparatus 100 of FIG. 1, according to another exemplary embodiment of the present invention. In FIG. 4, the user switches an existing content playlist to a new content playlist, based on a metadata item value of content that is currently being reproduced, by using a menu.

Referring to FIG. 4, a first view 410 includes a playlist switch button 411 for changing a metadata item value. The playlist switch button 411 may be, for example, a button attached to an outer surface of a content switching device, a touchpad, or a selection key. The existing content playlist displayed in the first view 410 of FIG. 4 includes contents of a metadata item ‘album’ having a metadata item value ‘Life in Cartoon’, and one of the contents is currently being produced.

If the user presses the playlist switch button 411 while the current content is currently being produced, a metadata item, which is a search base, is changed from ‘album’ to ‘genre’ in the second view 420. In this case, the control unit 130 confirms the genre of the current content that is currently being reproduced, and requests the search unit 150 to search for contents each having a metadata item value that is equal or similar to a metadata item value of the confirmed metadata item ‘genre’. The searched for contents may be registered in the new content playlist by using identification values, and may be reproduced according to the user's command or may be reproduced automatically.

An order in which the metadata item that is the search base is changed when the playlist switch button 411 is pressed may be pre-set for the apparatus 100. Alternatively, the order may be changed by the user by using an additional menu (not shown) for changing the order. In FIG. 4, whenever the playlist switch button 411 is pressed, the metadata item, which is the search base, is changed in the order of an album, a genre, and an artist as shown in views 410, 420 and 430.

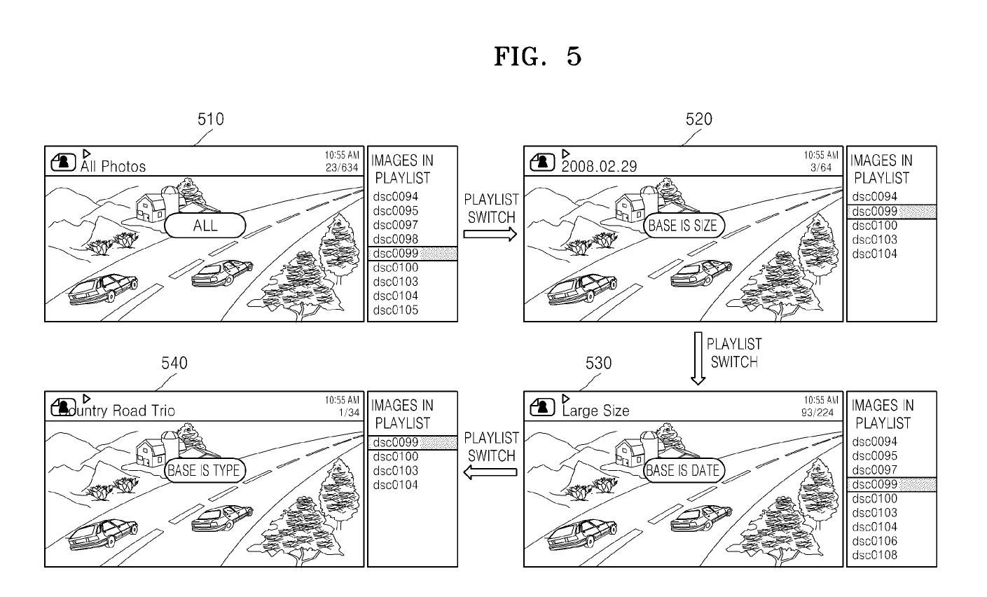

FIG. 5 is a view for explaining a method of driving the apparatus 100 of FIG. 1 when a content type is an image, according to an exemplary embodiment of the present invention. In FIG. 5, the user switches an existing content playlist to a new content playlist based on a metadata item value of content that is currently being reproduced by using a menu if a content type is an image. Metadata items of the image may be, for example, a date photographed, an image size (horizontal or vertical), a folder name, a place photographed, and an image type.

If the user selects content from contents of the existing content playlist 220 displayed on the display unit 140 by using the information input unit 110, the selected content is displayed in the first view 210 of FIG. 2. Although the existing content playlist 220 is displayed in order for the user to select the content, the existing content playlist 220 may also only be stored in the storage unit 120 without being displayed, and the contents included in the existing content playlist 220 may be reproduced in a predetermined order or in a random order.

If the user selects a metadata item, which is a base of the image that is currently being displayed in a first view 510, using the information input unit 110, the control unit 130 searches for contents each having a metadata item value associated with a metadata item value of the selected metadata item.

In FIG. 5, the existing content playlist 220 is switched when the metadata item that is the base is changed in the order of a content size (view 520), a date (view 530), and a content type (view 540). The searched contents may be included in a new content playlist that is generated by the control unit 130, may be stored in the storage unit 120, and then reproduced automatically in a predetermined order or in a random order. The existing content playlist 220 may only be stored in the storage unit 120 without being displayed or may be displayed together with the content that is currently being reproduced.

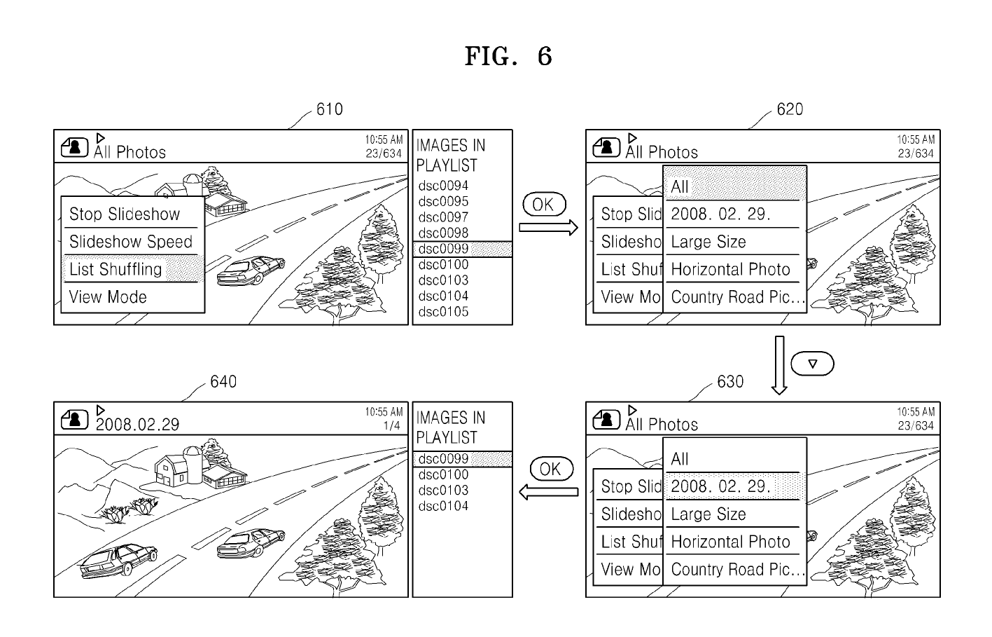

FIG. 6 is a view for explaining a method of driving the apparatus 100 of FIG. 1 when a content type is an image, according to another exemplary embodiment of the present invention. In FIG. 6, the user switches an existing content playlist based on a metadata item value of content that is currently being reproduced by using a menu.

Referring to FIG. 6, if the user selects a menu “List Shuffling” for switching a content playlist using the information input unit 110 in a first view 610, a sub menu for selecting a metadata item value or a metadata item which is a base for generating a new content playlist is displayed in a second view 620. Metadata item values of the content that is currently being reproduced are displayed in a third view 630. Next, the user may select a metadata item value, which is a base for generating the new content playlist, from the displayed metadata item values.

In FIG. 6, for example, the user selects a date of 2008.02.29 on which the current content, which is currently being reproduced, was generated as the metadata item value that is the base in the third view 630. Once the metadata item value that is the base is selected, the search unit 150 searches for contents each having the selected metadata item value which are then included in the new content playlist as shown in view 640. The contents included in the new content playlist may be reproduced according to the user's command or may be reproduced automatically.

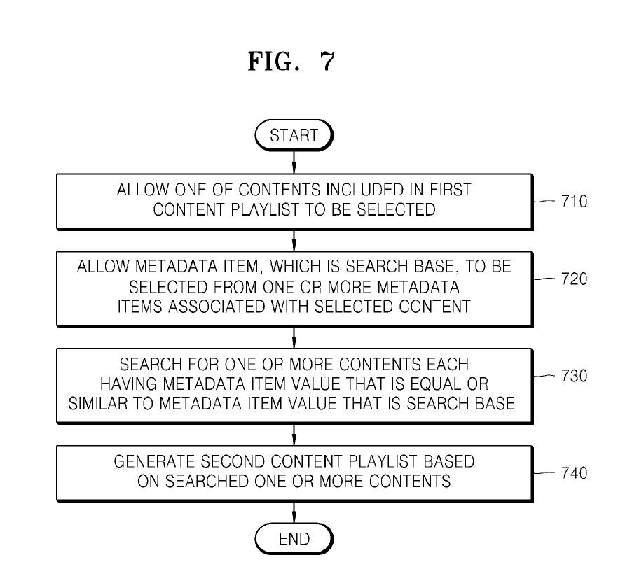

FIG. 7 is a flowchart illustrating a method of controlling a digital storage device by using an apparatus for generating a content playlist, according to an exemplary embodiment of the present invention.

Referring to FIG. 7, in operation 710, the apparatus allows one of contents included in a first content playlist to be selected. The content may be selected by a user, or may be selected automatically within the first content playlist.

In operation 720, the apparatus allows a metadata item, which is a search base, to be selected from one or more metadata items associated with the selected content. To this end, the user may gain access by using a menu, or may change between metadata items, which may be the search bases, using an input unit.

In operation 730, the apparatus extracts a metadata item value of the metadata item that is the search base from the content that is selected by the user or selected automatically, and searches for one or more contents each having a metadata item value that is equal or similar to the extracted metadata item value.

In operation 740, the apparatus generates a second content playlist based on the one or more contents searched for in operation 730. Information regarding each of the searched contents is used to generate the second content playlist. The information, which is identification information for identifying each of the searched for contents, may usually be information on a title, but may be information on another metadata item value for identifying each of the searched for contents.

The generated second content playlist may be stored in a predetermined storage unit. The contents included in the generated second content playlist may be reproduced, and the generated second content playlist may be managed along with other content playlists. The user may share the content playlists with other users, or may manage the content playlists by categorizing the content playlists according to a metadata type.

The present invention may be embodied as a computer-readable code having embodied thereon a program for executing a method of generating a content playlist based on metadata. The computer-readable recording medium may be any recording apparatus capable of storing data that is read by a computer system. Examples of the computer-readable recording medium include read-only memories (ROMs), RAMs, CD-ROMs, magnetic tapes, floppy disks, and optical data storage devices. The computer-readable recording medium may be a carrier wave that transmits data via the Internet, for example. The computer readable medium may be distributed among computer systems that are interconnected through a network, and the present invention may be stored and implemented as a computer readable code in the distributed system.

While the present invention has been particularly shown and described with reference to exemplary embodiments thereof, it will be understood by those of ordinary skill in the art that various changes in form and detail may be made therein without departing from the spirit and scope of the present invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of generating a content playlist based on metadata including one or more metadata items, the method comprising:
selecting an item of content from contents in a first content playlist;
selecting a metadata item, which is a search base, from one or more metadata items of metadata associated with the selected item of content;
searching for one or more contents each having a metadata item value equal to or similar to a metadata item value of the selected metadata item; and
generating a second content playlist using the searched for one or more contents.

2. The method of claim 1, wherein the selecting the one item of content from the contents included in the first content playlist comprises selecting by a user or by a control unit the one item of content.

3. The method of claim 1, wherein the selecting the metadata item, which is the search base, comprises selecting the metadata item while the selected item of content is being reproduced.

4. The method of claim 1, wherein the metadata comprises at least one metadata item selected from a group consisting of an artist, an album, a genre, a title, a size, a date, and a content format.

5. The method of claim 1, wherein the selecting the metadata item, which is the search base, comprises:
displaying the one or more metadata items of the metadata associated with the selected item of content; and
selecting the metadata item, which is the search base, from the displayed one or more metadata items.

6. The method of claim 1, wherein the selecting the metadata item, which is the search base, comprises:
receiving an input signal for changing the metadata item that is the search base; and
selecting a new metadata item, which is a second search base, in a preset metadata item change order when the input signal is received.

7. The method of claim 1, wherein the selecting the metadata item, which is the search base, comprises selecting the metadata item by pressing a touch panel.

8. An apparatus for generating a content playlist, the apparatus comprising:
an information input unit which inputs information;
a storage unit which stores a first content playlist including one or more contents;
a search unit which selects an item of content from the one or more contents in the first content playlist, and which searches for one or more contents each having a metadata item value equal or similar to a metadata item value of a metadata item of metadata associated with the selected item of content; and
a control unit which generates a second content playlist using the searched for one or more contents.

9. The apparatus of claim 8, further comprising a display unit which displays at least one selected from a group consisting of the selected item of content, the searched for one or more contents, the metadata, the first content playlist, and the second content playlist.

10. The apparatus of claim 8, wherein the metadata comprises at least one metadata item selected from a group consisting of an artist, an album, a genre, a title, a size, a date, and a content format.

11. The apparatus of claim 8, wherein the display unit displays at least one metadata item of the metadata associated with the selected content to allow selection of a metadata item that is a search base.

12. The apparatus of claim 9, wherein the control unit receives an input signal which changes a metadata item that is a search base, and changes the metadata item that is the search base in a preset metadata item change order when the input signal is received.

13. The apparatus of claim 1, wherein the information input unit is a touch panel.

14. A computer-readable recording medium having embodied thereon a program for executing a method, the method comprising: selecting an item of content from contents in a first content playlist;
selecting a metadata item, which is a search base, from one or more metadata items of metadata associated with the selected item of content;
searching for one or more contents each having a metadata item value equal to or similar to a metadata item value of the selected metadata item; and
generating a second content playlist using the searched for one or more contents.
